(19) United States
(12) Patent Application Publication
(10) Pub. No.: US 2008/0035889 A1
(43) Pub. Date: Feb. 14, 2008

(54) Supply of Steam and Hydrogen to a Process or Plant Producing Synthesis Gas

(76) Inventor: Andre Peter Steynberg, Vanderbulpark (ZA)

Correspondence Address: JOHN S. PRATT, ESQ;KILPATRICK STOCKTON, LLP, 1100 PEACHTREE STREET, ATLANTA, GA, 30309, US

(21) Appl. No.: 10/590,005

(22) PCT Filed: Feb. 14, 2005
(86) PCT No.: PCT/IB05/50565

§ 371 Date: May 3, 2007

Related U.S. Application Data
(60) Provisional application No. 60/546,152, filed on Feb. 20, 2004.

(51) Int. Cl. C01B 3/38

(52) U.S. Cl. 252/373; 422/162

(57) ABSTRACT

A method of supplying steam and a hydrogen feedstock to a primary process for producing synthesis gas includes, in a reformer of a secondary process which comprises a plurality of catalyst containing reforming passages, combusting a fuel to heat all of the reforming passages, whilst producing a hot synthesis gas by reforming a hydrocarbonaceous gas in the presence of process steam in some of the catalyst containing reforming passages only. The hot synthesis gas is cooled to produce steam which is supplied to the primary process. The cooled synthesis gas is treated to produce a hydrogen feedstock which is supplied to the primary process. The reforming passages not producing hot synthesis gas are cooled by passing a cooling medium through them and the hot synthesis gas exiting some of the reforming passages is separated from the cooling medium exiting other reforming passages.

THIS INVENTION relates to the supply of steam and hydrogen to a process or plant producing synthesis gas. In particular, the invention relates to a method of supplying steam and a hydrogen feedstock to a primary process for producing synthesis gas, to a method of starting a hydrocarbonaceous gas conversion plant which has start-up hydrogen and steam requirements and to an installation for producing steam and synthesis gas.

A hydrocarbonaceous gas such as methane, natural gas or associated gas may be converted to synthesis gas by means of well-known reforming processes. In large scale gas conversion plants, the hydrocarbons are reformed using oxygen and steam in a catalytic or non-catalytic reforming process. Thus, typically, the main synthesis gas generation step is an oxygen fired reformer, typically preceded by a pre-heat furnace. In some cases, a pre-reformer is used upstream of the oxygen fired reformer in order to remove hydrocarbons heavier than methane and partially to convert the hydrocarbons to synthesis gas comprising hydrogen and carbon monoxide. The use of a pre-reformer allows higher inlet temperatures to be used without excessive coke formation in the pre-heat furnace upstream of the oxygen fired reformer. As a result of the higher inlet temperature into the oxygen fired reformer, and the partial reforming taking place in the pre-reformer, the oxygen consumption in the oxygen fired steam reformer is decreased relative to a scheme without a pre-reformer. Another advantage provided by the use of a pre-reformer is that it is easier to avoid soot formation in the oxygen fired steam reformer.

An oxygen fired steam reformer requires an air separation unit (via cryogenic techniques or membrane-based processes) to produce the oxygen. An air separation unit uses large air compressors that are typically driven by steam turbines and/or electric motors.

Large gas conversion plants usually also have steam turbines that are used to generate electricity to be used within the plant to provide the electrical energy for various essential functions, such as the operation of instruments and pumps.

During normal operation of a large gas conversion plant, there are two main sources of steam. The first is the steam generated in the process of cooling hot gases exiting the oxygen fired reformer. The second is steam generated in a downstream synthesis process such as the production of higher hydrocarbons (whether normally gaseous, normally liquid or normally solid hydrocarbons) by the well-known Fischer-Tropsch synthesis process. This presents a problem in that the steam required to generate electricity and to drive the air separation unit turbines is not available prior to starting the plant. A further problem existing for plants consisting of multiple units, is that the failure of any individual steam generating unit causes a decrease in steam production which may have the consequence that the remaining units do not have sufficient steam to continue operation, resulting in a total plant shutdown at considerable cost.

The conventional solution to the aforementioned problems is to provide a start-up boiler that generates steam by heating boiler feed water in a fired heater in which a fuel is burned. Although any convenient fuel may be used, the fuel is often natural gas available at the plant site. The start-up boiler is thus used to provide the steam needed to start the plant, particularly the steam needed to run the first air separation unit and to drive the steam turbine used for electricity generation. Often, at least one start-up boiler is continuously kept online, mostly at turn-down or hot standby conditions. The reason for this is that steam production from the start-up boiler can be rapidly increased to supply steam to the gas conversion process, in the event of a unit failure, thereby to avoid a total plant shutdown.

Natural gas usually contains organic sulphur compounds that will poison catalysts used in the natural gas conversion processes of steam reforming and Fischer-Tropsch synthesis. Sulphur is typically removed to low levels using a zinc oxide sulphur adsorber. This is particularly effective for the removal of hydrogen sulphide but is less effective for removing organic sulphur. As a result, a hydrogenation step is applied upstream of the zinc oxide sulphur adsorber to convert organic sulphur to hydrogen sulphide. As will thus be appreciated, there is an early need for hydrogen to commission the sulphur removal systems prior to the commissioning of the downstream natural gas conversion processes.

The conventional solution to the early need for hydrogen is to provide a small steam reformer that can be used to manufacture synthesis gas from natural gas and steam provided by the start-up boiler, with hydrogen then being produced from the synthesis gas using processes known to those skilled in the art. If hydrogen is required for the hydro-processing of products of the gas conversion process then the size of this hydrogen generating unit will typically be large enough also to supply hydrogen for this function during normal plant operation. It will thus also be appreciated that the hydrogen generating unit will run far below its normal capacity when it is used only to provide hydrogen for the natural gas desulphurisation step during start-up of the gas conversion process or plant.

In a conventional hydrocarbonaceous gas conversion process or plant, a large amount of capital is thus spent on installing a start-up boiler or start-up boilers that are not fully utilised during normal operation. Furthermore, during normal operation, natural gas or other fuel is wasted to keep a boiler operating at turn-down conditions to ensure that steam is available during upset conditions. Also, during start-up or commissioning of such a hydrocarbonaceous gas conversion plant, a conventional hydrogen unit may be operating far below its normal capacity.

According to one aspect of the invention, there is provided a method of supplying steam and a hydrogen feedstock to a primary process for producing synthesis gas, the method including

in a reformer of a secondary process, which reformer comprises a plurality of catalyst containing reforming passages, combusting a fuel to provide heat and a hot combustion gas and using the heat to heat all of the reforming passages, whilst producing a hot synthesis gas by catalytically endothermically reforming a hydrocarbonaceous gas in the presence of process steam in some of the catalyst containing reforming passages only;

cooling the hot synthesis gas by heat exchange with water to produce steam and to provide cooled synthesis gas;

supplying said steam to the primary process for producing synthesis gas;

treating at least a portion of the cooled synthesis gas to produce a hydrogen feedstock;

supplying said hydrogen feedstock to the primary process for producing synthesis gas;

cooling the reforming passages not producing hot synthesis gas by passing a cooling or heat transfer medium through said reforming passages not producing hot synthesis gas; and

separating the hot synthesis gas exiting some of the reforming passages from the cooling or heat transfer medium exiting other reforming passages so that the hot synthesis gas and the cooling or heat transfer medium do not mix.

The cooled synthesis gas may be treated in conventional manner to produce the hydrogen feedstock. For example, the cooled synthesis gas may be subjected to a water shift reaction stage in which carbon monoxide is catalytically reacted with steam to produce carbon dioxide and hydrogen, whereafter the carbon dioxide is removed, e.g. by absorbing the carbon dioxide in a liquid such as a Benfield solution, to produce a hydrogen enriched stream. A conventional pressure swing adsorption stage may be used, alone or in combination with the carbon dioxide absorbing liquid, to separate pure hydrogen. Instead, membrane separation techniques may be used.

Preferably, the cooling or heat transfer medium is steam generated in the secondary process. The process of the invention may thus include drying or superheating the steam prior to passing the steam through some of the reforming passages as cooling or heat transfer medium. The steam may be dried or superheated in indirect heat exchange relationship with hot combustion gas from the reformer of the secondary process.

The steam may be produced at a pressure between about 60 bar and about 120 bar.

The method may thus include feeding a hydrocarbonaceous gas and process steam into the reformer to pass together through some of the reforming passages only. The process steam may be steam generated in the secondary process and may be the same steam from which the steam for use as cooling or heat transfer medium is obtained.

Typically, the hot synthesis gas exiting the reformer of the secondary process is cooled by heat exchange in a waste heat boiler supplied with boiler feed water. The method may include heating the boiler feed water in indirect heat exchange relationship with the hot combustion gas from the reformer of the secondary process, before feeding the boiler feed water into the waste heat boiler.

The method may include increasing steam production by transferring heat from the cooling or heat transfer medium to water and allowing the water to flash to produce steam. Thus, in one embodiment of the invention, the cooling or heat transfer medium is passed in indirect heat exchange relationship through the waste heat boiler to transfer heat to the boiler feed water in the waste heat boiler.

Typically, the reformer includes a fire box with any of a variety of reforming passage and burner arrangements inside the fire box, such as top fired, side fired, bottom fired or terrace wall fired. Preferably, the reformer is of the side fired type. In the side fired type, a single row of reforming passages is mounted along a centreline of the fire box. Burners burning fuel are mounted in several levels in the fire box walls and the flames are directed backwards towards the fire box walls. The reforming passages are heated by radiation from the furnace walls and flue or hot combustion gas and to a lesser extent by convection. The flow of the hydrocarbonaceous gas and steam in the reforming passages on the one hand and hot combustion gas on the other hand is countercurrent.

The method may include increasing the steam production in the secondary process by heating boiler feed water in the fire box of the reformer and allowing the water to flash to produce more steam. The initial process steam required by the secondary process may be generated in this fashion.

The method may include switching some reforming passages from receiving steam and a hydrocarbonaceous gas, to receiving the cooling or heat transfer medium, e.g. steam, only, so that some of the reforming passages are used to catalytically endothermically reform the hydrocarbonaceous gas and some reforming passages are only cooled by the cooling or heat transfer medium and thus do not produce any synthesis gas. Thus, as will be appreciated, the method of the invention allows rapid change from producing more hydrogen feedstock and less steam in the secondary process to producing less hydrogen feedstock and more steam in the secondary process.

The method may also include switching some reforming passages from receiving a cooling or heat transfer medium only, to receiving steam and a hydrocarbonaceous gas, thus increasing the production of synthesis gas and decreasing the production of steam in the secondary process.

The method may include combining a portion of the synthesis gas produced in the reformer of the secondary process with synthesis gas produced by the primary process. The method may also include combining a portion of the hydrogen feedstock produced by the secondary process with the synthesis gas produced by the primary process.

Typically, the primary process is a process employing an oxygen fired reformer, which may be a catalytic or non-catalytic reformer. The primary process may also employ a pre-reformer and/or a steam reformer.

The hydrocarbonaceous gas may include methane and in particular may be natural gas or associated gas. The primary process may include a Fischer-Tropsch hydrocarbon synthesis process to synthesise higher hydrocarbons from the synthesis gas produced by the primary process.

According to a further aspect of the invention, there is provided a method of starting a hydrocarbonaceous gas conversion plant which has start-up hydrogen and steam requirements, the method including

heating a reformer, comprising a plurality of catalyst containing reforming passages passing through a heating zone by combusting a fuel, thereby also producing a hot combustion gas;

generating steam by transferring heat generated by the combustion of the fuel to water in a steam generation circuit;

producing hot synthesis gas from some of the reforming passages only by feeding a hydrocarbonaceous gas and at least some of the generated steam into said reforming passages;

generating more steam by transferring heat from the hot synthesis gas to the water in the steam generation circuit;

supplying at least a portion of the steam to the hydrocarbonaceous gas conversion plant to satisfy the start-up steam requirements of the hydrocarbonaceous gas conversion plant;

treating at least a portion of the synthesis gas to produce a hydrogen feedstock; and

supplying at least a portion of said hydrogen feedstock to the hydrocarbonaceous gas conversion plant to satisfy the start-up hydrogen requirements of the hydrocarbonaceous gas conversion plant.

The method may include increasing the synthesis gas production and hence the hydrogen feedstock production by using more reforming passages for synthesis gas production as the hydrocarbonaceous gas conversion plant comes online.

The method may include initially generating maximum steam by using reforming passages not used for synthesis gas generation, to transfer heat from the heating zone into the steam generation circuit. This may include passing a heat transfer medium, e.g. steam, through the reforming passages thereby heating the heat transfer medium and transferring heat from the heated transfer medium to the water in the steam generation circuit to produce more steam.

Typically, the reforming passages are in the form of tubes, with metal tube walls, filled with a suitable steam reforming catalyst, such as nickel on a suitable support. The metal tube walls are thus used as heat transfer surfaces to transfer heat from the heating zone into the heat transfer medium. The heating zone is typically defined by a fire box of the reformer, as hereinbefore described.

The steam being fed to the reforming passages as heat transfer medium may be dry or superheated steam. The method may thus include drying or superheating the steam in indirect heat exchange relationship with hot combustion gas exiting the heating zone of the reformer before feeding the steam to the reforming passages.

The synthesis gas may be treated in conventional manner to produce the hydrogen feedstock, as hereinbefore described.

Typically, the hydrocarbonaceous gas conversion plant is a plant employing an oxygen fired reformer, which may be a catalytic or non-catalytic reformer. The plant may also employ a pre-reformer and/or a steam reformer and may form part of a Fischer-Tropsch hydrocarbon synthesis plant to synthesise higher hydrocarbons from synthesis gas. The hydrocarbonaceous gas conversion plant may thus also produce synthesis gas and the method may include combining a portion of the synthesis gas produced in the reformer with synthesis gas produced by the hydrocarbonaceous gas conversion plant, e.g. for further conversion. The method may also include combining a portion of the hydrogen feedstock with synthesis gas produced by the hydrocarbonaceous gas conversion plant.

The reformer may be a start-up reformer which is typically much smaller than a conventional oxygen fired reformer that may be used in the hydrocarbonaceous gas conversion plant.

According to another aspect of the invention, there is provided an installation for producing steam and synthesis gas, the installation including

a reformer which includes a plurality of catalyst containing reforming passages passing through a heating zone, the reforming passages having inlets grouped into at least two groups and outlets grouped into at least two groups;

a feed arrangement having a first condition in which a hydrocarbonaceous gas and steam can be fed into one group of inlets and a cooling or heat transfer medium only can be fed into another group of inlets, and a second condition in which a hydrocarbonaceous gas and steam can be fed into both of the groups of inlets;

a discharge arrangement having a first condition in which synthesis gas can be removed from the group of outlets of the reforming passages fed with the hydrocarbonaceous gas and steam and in which the cooling or heat transfer medium can be removed from the reforming passages fed with the cooling or heat transfer medium only, without mixing the synthesis gas and the cooling or heat transfer medium, and a second condition in which synthesis gas can be removed from both groups of outlets; and

a waste heat boiler to generate steam by means of heat exchange between the synthesis gas produced and boiler water.

The heating zone is typically defined by a fire box of the reformer, as hereinbefore described.

The heating zone may include heat exchange surfaces to allow heating of boiler water to increase steam production. These heat exchange surfaces may be in the form of boiler tubes installed in the heating zone.

The installation may include a heat exchanger to exchange heat between hot combustion gas from the heating zone and boiler feed water fed to the waste heat boiler and/or steam produced by the waste heat boiler.

The discharge arrangement may be configured to pass the cooling or heat transfer medium to the waste heat boiler for indirect heat exchange with boiler water in the waste heat boiler, thereby cooling the cooling or heat transfer medium.

The cooling or heat transfer medium may be steam and the feed arrangement may thus be configured to receive steam from the waste heat boiler in both its first and second conditions, and the steam passing as cooling or heat transfer medium from the reforming passages through the waste heat boiler may be piped to join the steam from the waste heat boiler.

The installation may include a hydrogen generating unit to produce a hydrogen or hydrogen enriched stream from at least a portion of the synthesis gas.

The invention will now be described, by way of example only, with reference to the accompanying diagrammatic drawings in which

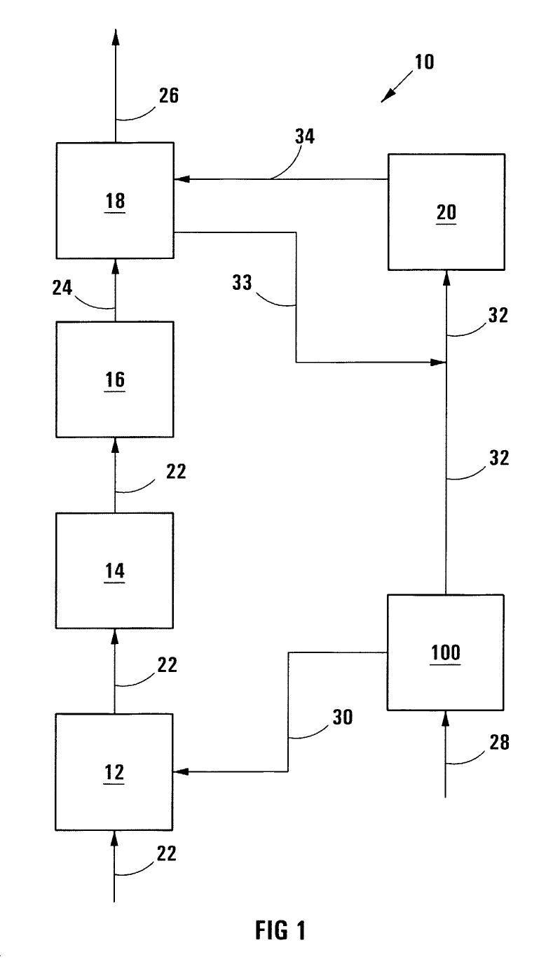

FIG. 1 shows a simplified flow diagram of a primary process for producing synthesis gas, with a secondary process to supply steam and a hydrogen feedstock in accordance with the invention to the primary process; and

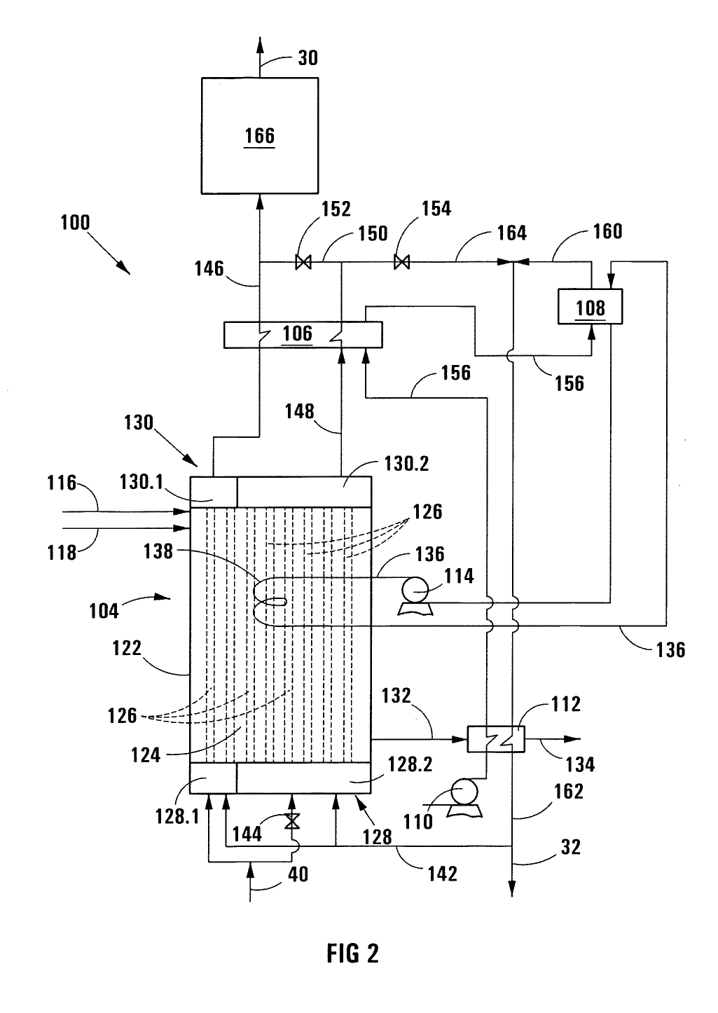

FIG. 2 shows a simplified flow diagram of the secondary process of FIG. 1.

Referring to FIG. 1 of the drawings, reference numeral 10 generally indicates a primary process for producing synthesis gas, with a secondary process 100 embodying a method in accordance with the invention being present to supply steam and a hydrogen feedstock to the primary process 10.

The primary process 10 includes a hydrogenation stage 12, a sweetening stage 14, a pre-reforming stage 16, an oxygen fired reforming stage 18 and an air separation unit 20. A natural gas feedstock line 22 leads into the hydrogenation stage 12 and from there to the sweetening stage 14, before entering the pre-reforming stage 16. From the pre-reforming stage 16, a pre-reformed gas line 24 leads to the oxygen fired reforming stage 18, from which a synthesis gas line 26 leads.

A natural gas feedstock line 28 leads into the secondary process 100 and an export hydrogen feedstock line 30 connects the secondary process 100 with the hydrogenation stage 12 of the primary process 10. An export steam line 32 leads from the secondary process 100 to the air separation unit 20 of the primary process 10. A steam export line 33 leads from the oxygen fired reforming stage 18 to the air separation unit 20. An oxygen feed line 34 also connects the air separation unit 20 with the oxygen fired reforming stage 18.

The process 10 produces synthesis gas, which can then be used in a conventional manner to produce a multitude of products, e.g. Fischer-Tropsch derived waxes, lubrication oils, diesel or the like. This is effected by feeding natural gas, which is a hydrocarbonaceous gas, along the natural gas feedstock line 22 into the hydrogenation stage 12. In the hydrogenation stage 12, organic sulphur compounds in the natural gas is reacted with hydrogen to convert the organic sulphur compounds to hydrogen sulphide. The natural gas is then fed from the hydrogenation stage 12 to the sweetening stage 14, where sulphur is removed to low levels from the natural gas by using a zinc oxide sulphur adsorber. The natural gas is thus sweetened in the sweetening stage 14 before being fed to the pre-reforming stage 16. The pre-reforming stage 16 removes hydrocarbons heavier than methane and partially converts the hydrocarbons to synthesis gas comprising hydrogen and carbon monoxide. The partially reformed natural gas is fed from the pre-reforming stage 16 to the oxygen fired reforming stage 18, which is the main synthesis gas generation step for the process 10. In the oxygen fired reforming stage 18, one or more oxygen fired reformers, which may be catalytic or non-catalytic, further reform the natural gas to produce synthesis gas which is withdrawn along the synthesis gas line 26. The oxygen fired reforming stage 18 requires oxygen, or oxygen enriched air, fed by means of the oxygen feed line 34 from the air separation unit 20, to be reacted with pre-reformed natural gas fed to the oxygen fired reforming stage 18 to provide the energy for the endothermic steam reforming of the natural gas. The oxygen fired reforming stage 18 also requires steam for the reforming reactions. At the same time, the air separation unit 20 requires steam to drive steam turbines used to drive large air compressors and/or to generate power used in the air separation unit 20.

From the above, it is thus clear that there is an early need, when starting or commissioning the process 10, for the supply of a hydrogen feedstock and steam to some of the stages of the process 10. In accordance with the invention, the hydrogen feedstock and the steam are provided by the secondary process 100, which typically does not include a start-up boiler, in contrast to conventional methods or processes of which the Applicant is aware to provide a hydrogen feedstock and steam to a carbonaceous gas conversion process such as the process 10.

The process 100 is illustrated in more detail in FIG. 2 of the drawings. The process 100 includes a side-fired steam reformer 104 which is relatively small compared to the reformer or reformers of the reforming stage 18. A waste heat boiler 106 and a steam drum 108, together with a boiler feed water pump 110 form part of a steam generation circuit. The steam generation circuit of the process 100 further includes a heat exchanger 112 and a steam drum water circulation pump 114.

The steam reformer 104 is provided with a natural gas or fuel gas feed line 116 and an air feed line 118.

The steam reformer 104 comprises a fire box 122 defining a heating zone 124 through which a plurality of catalyst containing reforming tubes 126 extend. The tubes 126 are arranged in single file. The reforming tubes 126 thus define catalyst containing reforming passages which extend between an inlet header 128 and an outlet header 130. As can be clearly seen in FIG. 2 of the drawings, the reforming tubes 126 are grouped by means of the inlet header 128 and the outlet header 130 into two groups with separated inlets and outlets.

A hot combustion gas line 132 leads from the heating zone 124 to the heat exchanger 112. The heat exchanger 112 is also provided with a flue gas line 134.

A steam drum water circulation line 136 leads from the steam drum 108 through the steam drum water circulation pump 114 into boiler tubes 138 (shown schematically) inside the steam reformer fire box 122 and back to the steam drum 108. The boiler tubes 138 thus also form part of the steam generation circuit.

A feed arrangement comprising a natural gas feed line 140 and a steam feed line 142 is provided for the steam reformer 104. For illustrative purposes, the inlet header 128 will be referred to as having two sides, namely a left hand side 128.1 and a right hand side 128.2 and in similar fashion the outlet header 130 is described as having a left hand side 130.1 and a right hand side 130.2. The natural gas feed line 140 feeds into both the left hand side 128.1 and the right hand side 128.2 of the inlet header 128 but a valve 144 is provided selectively to allow or to prevent the feeding of natural gas into the right hand side 128.2. The steam feed line 142 also feeds into both the left hand side 128.1 and the right hand side 128.2 of the inlet header 128.

An outlet arrangement for the steam reformer 104 is also provided, comprising a synthesis gas withdrawal line 146 and a superheated steam line 148. The synthesis gas withdrawal line 146 leads from the left hand side 130.1 of the outlet header 130 and the superheated steam line 148 leads from the right hand side 130.2 of the outlet header 130.

Both the synthesis gas withdrawal line 146 and the superheated steam line 148 pass through the waste heat boiler 106.

The superheated steam line 148, once having passed through the waste heat boiler 106, turns into a cooled steam line 164. A connecting line 150 with a valve 152 is provided between the lines 146 and 164, downstream of the waste heat boiler 106. A valve 154 is provided in the line 164, downstream of the line 150.

A boiler feed water line 156 leads from a supply of boiler feed water (not shown) through the boiler feed water pump 110, via the heat exchanger 112, into the waste heat boiler 106 and from the waste heat boiler 106 into the steam drum 108. A saturated steam line 160 leads from the steam drum 108 and is joined by the cooled steam line 164 before it passes through the heat exchanger 112. From the heat exchanger 112, a dry steam line 162 is provided which feeds into the export steam line 32 to withdraw dry export steam from the steam circuit. The steam feed line 142 branches from the dry steam line 162.

The synthesis gas withdrawal line 146 leading from the waste heat boiler 106 enters a hydrogen generating unit 166, from which the export hydrogen feedstock line 30 leads.

As mentioned hereinbefore, the process 100 is used to provide a hydrogen feedstock and steam to the process 10. In the embodiment of the invention shown in the drawings, the process 100 entirely replaces a conventional start-up fired boiler and a conventional small steam reformer that can be used to manufacture hydrogen from natural gas and steam provided by the start-up boiler.

In use, natural gas or fuel gas and air are respectively fed by means of the natural gas feed line 116 and air feed line 118 into the steam reformer fire box 122 where combustion of the gas takes place to provide a heat source for the steam reformer 104. The gas is combusted at elevated pressure in burners (not shown) mounted at several levels in the fire box 122 and arranged to direct the flames towards the walls of the fire box 122. In order to produce at least a portion of the steam required from and/or for the process 100, steam drum water is circulated by means of the steam drum water circulation pump 114 and the steam drum water circulation line 136 through the boiler tubes 138 in the steam reformer fire box 122 and returned to the steam drum 108, where the water flashes to produce saturated steam withdrawn from the steam drum 108 by means of the saturated steam line 160. This arrangement also provides for the initial production of steam to allow the reformer 104 to be started.

The heat generated by combustion of fuel or natural gas in the burners of the steam reformer fire box 122 is used to heat the reforming tubes 126. The reforming tubes 126 are typically filled with catalyst comprising nickel on a suitable support, e.g. alumina, magnesia, zirconia, or calcium-aluminate cement. Typically, the temperature inside the reforming tubes 126 is in the range of 650° C. to 950° C. For purposes of starting or commissioning the process 10, natural gas and steam are initially fed into the left hand side 128.1 of the inlet header 128. Thus, initially, the valve 144 is closed and natural gas enters only the reforming tubes extending between the left hand side 128.1 of the inlet header 128 and the left hand side 130.1 of the outlet header 130. Saturated steam from the steam drum 108 passes in indirect heat exchange relationship through the heat exchanger 112, which is fed with hot combustion gas from the heating zone 124 by means of the hot combustion gas line 132. In the heat exchanger 112, the saturated steam is heated and thereby dried and the hot combustion gas is further cooled and withdrawn as flue gas by means of the flue gas line 134. The dry steam is fed by means of the dry steam line 162 and the steam feed line 142 into both the left hand side 128.1 and the right hand side 128.2 of the inlet header 128.

In the reforming tubes 126 fed with both natural gas and steam, the natural gas is reformed to produce a synthesis gas comprising carbon monoxide and hydrogen. Typically, the steam is present in the reforming tubes 126 in an excess over that required for the reforming reactions in order to reduce the risk of formation of carbon deposits on the reforming catalyst. The synthesis gas or reformed gas thus typically also comprises carbon dioxide, unreacted steam and methane.

During this start-up period, the valve 152 is closed and the valve 154 is open. Thus, synthesis gas from the left hand side 130.1 of the outlet header 130 is withdrawn by means of the synthesis gas withdrawal line 146 and passed in indirect heat exchange relationship through the waste heat boiler 106 before entering the hydrogen generating unit 166. In the hydrogen generating unit 166, the synthesis gas is treated in conventional manner to provide a hydrogen feedstock. Typically, this includes subjecting the synthesis gas to a water gas shift reaction by mixing the synthesis gas with steam and passing the mixture over a suitable shifting catalyst which promotes the water gas shift reaction. Some of the carbon monoxide and steam in the synthesis gas is thus converted to carbon dioxide and hydrogen, thereby further enriching the synthesis gas in hydrogen. The carbon dioxide is then removed, e.g. by absorbing the carbon dioxide in a Benfield solution, thus still further enriching the synthesis gas in hydrogen. This hydrogen enriched gas is then subjected to a conventional pressure swing adsorption stage where by means of conventional pressure swing adsorption a hydrogen feedstock is produced. Instead, a membrane process may be employed. The hydrogen feedstock is then fed by means of the export hydrogen feedstock line 30 to the hydrogenation stage 12 of the process 10.

The dry steam fed into the right hand side 128.2 of the inlet header 128 passes through the reforming tubes 126 and is superheated. The superheated steam is withdrawn by means of the superheated steam line 148 from the right hand side 130.2 of the outlet header 130 and passes in indirect heat exchange relationship through the waste heat boiler 106. In the waste heat boiler 106, the superheated steam is cooled but remains dry and the cooled dry steam is then fed into the saturated steam line 160. During all of this, the boiler feed water pump 110 pumps boiler feed water by means of the boiler feed water line 156 through the heat exchanger 112 to recover heat from the hot combustion gas passing through the heat exchanger 112, and through the waste heat boiler 106 to recover heat from the hot synthesis gas and the superheated steam, and into the steam drum 108, where the water is allowed to flash to add steam to the saturated steam line 160. In this manner, sufficient saturated steam is produced, which is then dried in the heat exchanger 112, to provide export steam which can be fed by means of the export steam line 32 to the air separation unit 20 and possibly other steam requiring units of the process 10, for start-up purposes. During this start-up period, the steam passing through the reforming tubes 126 extending between the right hand side 128.2 of the inlet header 128 and the right hand side 130.2 of the outlet header 130 acts as a cooling or heat transfer medium, removing heat from the hot combustion gas in the heating zone 124 and transferring the heat into the steam generation circuit thereby increasing steam production. The intensity of firing of fuel in the steam reformer fire box 122 and the flow rate of steam through the steam only reformer tubes 126 (using a flow control valve not shown) are available as control variables to ensure that the required quality of export steam is produced.

Once online to a sufficient extent, the process 10 generates sufficient steam from the cooling of hot synthesis gas generated in the oxygen fired reforming stage 18 and possibly from further downstream unit operations, such as a Fischer-Tropsch synthesis process, which converts the synthesis gas into desired products or intermediates, to be self-sufficient in steam production and to export steam to the air separation unit 20. When this point is reached, the valves 144 and 152 are opened and the valve 154 is closed. Natural gas and steam are thus fed into all of the reforming tubes 126 and the synthesis gas produced in all the reforming tubes 126 is withdrawn by means of the synthesis gas withdrawal line 146, and the superheated steam line 148. The hot synthesis gas in the line 146 and the line 148 passes through the waste heat boiler 106 before being combined via the connecting line 150. In this condition, no steam thus flows from the steam reformer 104 through the waste heat boiler 106 into the saturated steam line 160.

If necessary, e.g. in case of a process upset in the process 10, the process 100 can be rapidly changed from producing maximum synthesis gas (and thus maximum hydrogen feedstock) and a relatively small amount of export steam (i.e. with the valves 144 and 152 open and the valve 154 closed) to producing a relatively large amount of export steam and a relatively small amount of synthesis gas (and thus hydrogen feedstock). This is easily achieved by closing the valve 144 and purging the relevant reforming tubes 126 and the line 148 with steam, before opening the valve 154 and closing the valve 152.

If desired, when producing the maximum amount of synthesis gas and hydrogen feedstock and the minimum amount of export steam, any excess synthesis gas can be combined with the synthesis gas produced in the oxygen fired reforming stage 18 of the process 10, for further conversion. Excess hydrogen feedstock may also be combined with the synthesis gas produced in the oxygen fired reforming stage 18 of the process 10, for further conversion.

It is an advantage of the invention, as illustrated, that it is not necessary to invest capital in a start-up boiler and possibly also in a hydrogen generating unit that are not operated at full capacity at all times. With the invention, as illustrated, natural gas or other fuel is also not wasted to keep a boiler operating at turned-down conditions to ensure that steam is available during plant upset conditions. Instead, the steam reformer 104, which is in fact a multi-purpose unit, can be rapidly switched from producing little export steam to maximum export steam and back to little export steam, as required.

1-20. (canceled)

21. A method of supplying steam and a hydrogen feedstock to a primary process for producing synthesis gas, the method including
in a reformer of a secondary process, which reformer comprises a plurality of catalyst containing reforming passages, combusting a fuel to provide heat and a hot combustion gas and using the heat to heat all of the reforming passages, whilst producing a hot synthesis gas by catalytically endothermically reforming a hydrocarbonaceous gas in the presence of process steam in some of the catalyst containing reforming passages only;
cooling the hot synthesis gas by heat exchange with water to produce steam and to provide cooled synthesis gas;
supplying said steam to the primary process for producing synthesis gas;
treating at least a portion of the cooled synthesis gas to produce a hydrogen feedstock;
supplying said hydrogen feedstock to the primary process for producing synthesis gas;
cooling the reforming passages not producing hot synthesis gas by passing a cooling or heat transfer medium through said reforming passages not producing hot synthesis gas; and
separating the hot synthesis gas exiting some of the reforming passages from the cooling or heat transfer medium exiting other reforming passages so that the hot synthesis gas and the cooling or heat transfer medium do not mix.

22. The method as claimed in claim 21, in which the cooling or heat transfer medium is steam generated in the secondary process.

23. The method as claimed in claim 22, which includes drying or superheating the steam prior to passing the steam through some of the reforming passages as cooling or heat transfer medium.

24. The method as claimed in claim 23, in which the steam is dried or superheated in indirect heat exchange relationship with hot combustion gas from the reformer of the secondary process.

25. The method as claimed in claim 22, which includes feeding a hydrocarbonaceous gas and process steam into the reformer to pass together through some of the reforming passages only, the process steam being steam generated in the secondary process and being the same steam from which the steam for use as cooling or heat transfer medium is obtained.

26. The method as claimed in claim 21, in which the hot synthesis gas exiting the reformer of the secondary process is cooled by heat exchange in a waste heat boiler supplied with boiler feed water, the method further including heating the boiler feed water in indirect heat exchange relationship with the hot combustion gas from the reformer of the secondary process, before feeding the boiler feed water into the waste heat boiler.

27. The method as claimed in claim 21, which includes increasing steam production by transferring heat from the cooling or heat transfer medium to water and allowing the water to flash to produce steam.

28. The method as claimed in claim 21, which includes switching some reforming passages from receiving steam and a hydrocarbonaceous gas, to receiving the cooling or heat transfer medium only, so that some of the reforming passages are used to catalytically endothermically reform the hydrocarbonaceous gas and some reforming passages are only cooled by the cooling or heat transfer medium and thus do not produce any synthesis gas.

29. The method as claimed in claim 21, which includes switching some reforming passages from receiving a cooling or heat transfer medium only, to receiving steam and a hydrocarbonaceous gas, thus increasing the production of synthesis gas and decreasing the production of steam in the secondary process,

30. The method as claimed in claim 21, in which the primary process includes a Fischer-Tropsch hydrocarbon synthesis process to synthesise higher hydrocarbons from the synthesis gas produced by the primary process.

31. A method of starting a hydrocarbonaceous gas conversion plant which has start-up hydrogen and steam requirements, the method including heating a reformer, comprising a plurality of catalyst containing reforming passages passing through a heating zone by combusting a fuel, thereby also producing a hot combustion gas;
generating steam by transferring heat generated by the combustion of the fuel to water in a steam generation circuit;
producing hot synthesis gas from some of the reforming passages only by feeding a hydrocarbonaceous gas and at least some of the generated steam into said reforming passages;
generating more steam by transferring heat from the hot synthesis gas to the water in the steam generation circuit;
supplying at least a portion of the steam to the hydrocarbonaceous gas conversion plant to satisfy the start-up steam requirements of the hydrocarbonaceous gas conversion plant;
treating at least a portion of the synthesis gas to produce a hydrogen feedstock; and
supplying at least a portion of said hydrogen feedstock to the hydrocarbonaceous gas conversion plant to satisfy the start-up hydrogen requirements of the hydrocarbonaceous gas conversion plant.

32. The method as claimed in claim 31, which includes increasing the synthesis gas production and hence the hydrogen feedstock production by using more reforming passages for synthesis gas production as the hydrocarbonaceous gas conversion plant comes online.

33. The method as claimed in claim 31, which includes initially generating maximum steam by using reforming passages not used for synthesis gas generation, to transfer heat from the heating zone into the steam generation circuit, by passing a heat transfer medium through the reforming passages thereby heating the heat transfer medium and transferring heat from the heated transfer medium to the water in the steam generation circuit to produce more steam.

34. The method as claimed in claim 33, in which steam is fed to the reforming passages as heat transfer medium, the method including drying or superheating the steam in indirect heat exchange relationship with hot combustion gas exiting the heating zone of the reformer before feeding the steam to the reforming passages.

35. An installation for producing steam and synthesis gas, the installation including
a reformer which includes a plurality of catalyst containing reforming passages passing through a heating zone, the reforming passages having inlets grouped into at least two groups and outlets grouped into at least two groups;
a feed arrangement having a first condition in which a hydrocarbonaceous gas and steam can be fed into one group of inlets and a cooling or heat transfer medium only can be fed into another group of inlets, and a second condition in which a hydrocarbonaceous gas and steam can be fed into both of the groups of inlets;
a discharge arrangement having a first condition in which synthesis gas can be removed from the group of outlets of the reforming passages fed with the hydrocarbonaceous gas and steam and in which the cooling or heat transfer medium can be removed from the reforming passages fed with the cooling or heat transfer medium only, without mixing the synthesis gas and the cooling or heat transfer medium, and a second condition in which synthesis gas can be removed from both groups of outlets; and
a waste heat boiler to generate steam by means of heat exchange between the synthesis gas produced and boiler water.

36. The installation as claimed in claim 35, in which the heating zone is defined by a fire box of the reformer.

37. The installation as claimed in claim 35, in which the heating zone includes heat exchange surfaces to allow heating of boiler water to increase steam production.

38. The installation as claimed in claim 35, which includes a heat exchanger to exchange heat between hot combustion gas from the heating zone and boiler feed water fed to the waste heat boiler and/or steam produced by the waste heat boiler.

39. The installation as claimed in claim 38, in which the discharge arrangement is configured to pass the cooling or heat transfer medium to the waste heat boiler for indirect heat exchange with boiler water in the waste heat boiler, thereby cooling the cooling or heat transfer medium.

40. The installation as claimed in claim 35, which includes a hydrogen generating unit to produce a hydrogen or hydrogen enriched stream from at least a portion of the synthesis gas.
